(19) United States
(12) Patent Application Publication
(10) Pub. No.: US 2013/0267655 A1
(43) Pub. Date: Oct. 10, 2013

(54) MOLDED POLYURETHANE ELASTOMER PARTS MADE OF DIPHENYLMETHANE DIISOCYANATE-BASED NCO PREPOLYMERS AND METAL SALT COMPLEXES, AND A METHOD FOR PRODUCING SAME

(71) Applicant: Jens Krause, Leverkusen (DE)

(72) Inventor: Jens Krause, Leverkusen (DE)

(73) Assignee: Bayer Intellecutal Property GmbH, Monheim (DE)

(21) Appl. No.: 13/988,910

(22) PCT Filed: Nov. 18, 2011
(86) PCT No.: PCT/EP11/70423

§ 371 Date: Jun. 19, 2013

(30) Foreign Application Priority Data
Nov. 23, 2010 (EP) 10306284.0

(51) Int. Cl. C08G 18/83

(52) U.S. Cl. CPC C08G 18/838
USPC 524/590; 525/460; 525/440.04

(57) ABSTRACT

The invention relates to novel molded polyurethane elastomer parts made of diphenylmethane diisocyanate-based NCO-functional prepolymers and diphenylmethandiamine blocked with metal salts and to a method for producing same.

The present invention relates to novel polyurethane elastomer moldings made of NCO-functional, diphenylmethane-diisocyanate-based prepolymers and of metal-salt-blocked diphenylmethanediamine (MDA), another term used hereinafter for these materials being complexes of MDA, and to a method for producing these.

MDI (diphenylmethane diisocyanate) is an industrially important group of polyisocyanates. In respect of its structure it is very heterogeneous, and comprises monomer types characterized in that they have two aromatic structural elements bonded by way of only one methylene bridge, and also higher oligomers which have more than two aromatic structural elements and have more than one methylene bridge, these being termed polymeric MIDI.

The synthesis of monomeric MDI causes the 4,4′- and 2,4′-isomers to predominate. The 2,2′-isomer also occurs less frequently and to a lesser extent, and has very little industrial value.

The ratio of monomer MDI to polymer MDI, and also the proportions of the 2,4′-and 4,4′-isomers in the monomer MDI, can be varied widely by varying the synthesis conditions during the production of the amine precursor.

The crude MDI produced during MDI synthesis is mostly isolated by distillation, and as a function of technical resource used it is possible to isolate either almost isomerically pure fractions with 4,4′-MDI contents of, for example, more than 97.5% by weight, or else isomer mixtures with contents of about 50% by weight of each of 4,4′- and 2,4′-compounds. Mixtures obtainable commercially comprise at most 60% by weight of 2,4′-MDI.

Pure 2,4′-isomer is obtained by a specific distillation process. It is preferable that 2,4′-MDI with low 2,2′-MDI content is produced by the method of EP-A 1 561 746, and that this material is used.

Complexes of MDA (diphenylmethanediamine) have been described in 1973 by DuPont. An advantage of these complexes (blocked MDA) is that they do not react with, for example, isocyanates until a particular temperature has been reached (thermal latency). It is therefore possible to obtain reaction mixtures that are stable in storage and to delay the processing of these for a number of hours or indeed days, as long as particular temperatures are not exceeded during storage. The reaction mixture hardens only when this temperature is exceeded.

However, a major disadvantage in the use of blocked amines of this type for the production of polyurethanes is that thick-walled parts do not cure throughout the material, and the only possibility is therefore to produce polyurethane coatings of thickness <5 mm (examples being impregnated textiles). It is not possible to produce typical cast elastomer products, such as sieves, wheels or rolls, with wall thicknesses >10 mm, since the reaction mixture does not harden completely. Reaction mixtures of this type preferentially harden only in direct contact with the mold, which typically has the highest temperature, within a layer measuring from 1 to 2 mm. Production has hitherto been restricted to coatings with thicknesses <5 mm. It is believed that the lack of hardening is due to the high content of free, unreacted isocyanate in the NCO prepolymers. Much resource has now been devoted to solving this problem. Attempts have therefore been made to produce low-monomer-content NCO prepolymers. However, the method mostly used here does not involve producing a typical NCO prepolymer in the usual way and then removing the free unreacted isocyanate from the NCO prepolymer by distillation. The viscosity of low-monomer-content NCO prepolymers of this type would be much too high. Another technique is therefore used to obtain low-monomer-content NCO prepolymers. When an NCO prepolymer that does not have low monomer content is produced, isocyanate and polyol are reacted with one another, as is well known, and when MDI is used as isocyanate the content of the free, unreacted isocyanate in the NCO prepolymer here is usually at least 5% by weight. The index (the ratio of NCO groups to OH groups) is typically from 1.5 to 3. In contrast, when low-monomer-content NCO prepolymers are produced a precursor (“NCO prepolymer”) is first produced from isocyanate and polyol, and has an extremely high excess of free isocyanate. The index of this precursor is typically from 5 to 8. The free isocyanate, present in marked excess, is then removed in a second step by distillation. There are differences not only between the processes for producing low-monomer-content NCO prepolymers and NCO prepolymers that do not have low monomer content but also between the constitutions of the respective NCO prepolymers and their properties.

In the case of the low-monomer-content NCO prepolymers, a typical structure is composed of the reaction product of two isocyanates A and of a polyol B, therefore being ABA. Because of the large excess of isocyanate (high index) in relation to polyol, the probability of formation of larger units, such as ABABA, is very small. These low-monomer-content NCO prepolymers comprise only ABA units, and the OH number of the polyol B therefore determines the NCO content of the prepolymer. There are therefore restrictions on the variation of the properties of NCO prepolymers of this type.

In contrast, NCO prepolymers that do not comprise low monomer content (also termed batch prepolymers or non-thin-layer prepolymers) have a distribution of ABA, ABABA, ABABABA, etc., and also comprise free isocyanate A. Since there is only a small excess of isocyanate with respect to polyol (index from 1.5 to 3) during the production of NCO prepolymers that do not have low monomer content, the process known as pre-extension occurs (where ABA reacts with a further polyol B, which then reacts with further isocyanate A, thus giving ABABA). US 2008/0146765 gives an overview of the structure of NCO prepolymers of this type.

Typical techniques for the removal of free isocyanate from NCO prepolymers are falling-film distillation, thin-layer distillation, and also distillation using an entrainer (entrainer: gas and/or solvent) in vacuo, solvent extraction, membrane filtration, and removal by way of molecular sieves. The technique most often used is thin-layer distillation. These types of distillation processes were initially used only on TDI-based NCO prepolymers, because of the vapor pressure of tolylene diisocyanate (TDI). However, a major disadvantage here is that the resultant polyurethanes from reaction of MDA complexes with the NCO prepolymer have markedly poorer mechanical properties than the corresponding polyurethanes made from thin-layer-distilled NCO prepolymers cured with traditional unblocked aminic crosslinking agents, e.g. 4,4′-methylenebis(2-chloroaniline) (MOCA) or butanediol (US 2008/0146765). However, the reaction of low-monomer-content TDI-based prepolymers with MDA complexes can be used to produce elastomer parts with substantial walls.

The origin of the driving force for the production of low-monomer-content to practically monomer-free NCO prepolymers is, in addition to the abovementioned problems with the reaction with complexes of MDA—the high vapor pressure of 2,4/2,6-TDI and the attendant health hazards. The NCO prepolymers based on aliphatic diisocyanates, such as hexamethylene diisocyanate (HDI) or isophorone diisocyanate (IPDI), have to be considered as even more critical in this respect. In principle, this type of health hazard is also present with MDI, but to a markedly reduced extent because its vapor pressure is lower than that of TDI. MDI also differs from TDI in that the former is not suspected of being carcinogenic. Since the complexes of MDA do not react adequately with prepolymers that have not been freed from monomeric isocyanates, here again it is necessary to subject the MDI-based NCO prepolymers to thin-layer distillation (US 2008/0146765). Thin-layer distillation of the 4,4′-MDI-based NCO prepolymers and subsequent reaction of these with blocked MDA is the only way of obtaining polyurethanes with comparable or better properties (US 2008/0146765).

Free isocyanate content in 4,4′-MDI-based NCO prepolymers that have not been subjected to thin-layer distillation is above 5%. Lower content of free isocyanate is not feasible since the viscosity of the prepolymer would be much too high for further processing. It is therefore necessary to resort to low-monomer-content NCO prepolymers having ABA structure (isocyanate-polyol-isocyanate). The viscosities of NCO prepolymers that do not have low monomer content with relatively low content of free isocyanate and having a large number of segments in the structure of the prepolymer (e.g. ABABA) would be much too high.

The major disadvantage of the production of low-monomer-content MDI-based NCO prepolymers is the high melting point of 4,4′-MDI. In order to eliminate this disadvantage, toxic solvents, such as dioctyl phthalate, have been added as entrainers (US 2008/0146765) in order to reduce the melting point, so that 4,4′-MDI does not crystallize out during thin-layer distillation. Another alternative would have been to operate the distillation vessel above the melting point of MDI (i.e. above 40° C.) instead of at room temperature, but as a counter-measure it would have been necessary to operate the distillation system at 140° C., or preferably at 160° C., and this would have led to decomposition of the NCO prepolymer (US 2008/0146765). The NCO prepolymers also then always comprise solvent residues (about 0.1-0.2% by weight). Solvent-containing NCO prepolymers of this type are undesirable, however. Another disadvantage of thin-layer distillation is high costs, since this is a process that uses large amounts of energy. The plant is moreover very complicated, and the production process can therefore be carried out only at appropriately equipped sites with a high level of capital expenditure. Another major disadvantage is that the complex plant is unreliable. Another major disadvantage is that continuously operating plant is involved. Whereas NCO prepolymers containing monomer are normally produced by the stirred-tank process, when thin-layer plant is used it is necessary to operate continuously because of feed by way of vacuum evaporators. Thin-layer plant is about 50-250 times more expensive than stirred-tank plant.

The low-monomer-content TDI-based NCO prepolymers or low-monomer-content 4,4′-MDI-based NCO prepolymers currently available cannot be used to produce products which have similar properties throughout, since by way of example hardness varies in the center in comparison with the surface of the product (polyurethane elastomer).

4,4′-MDI-based NCO prepolymers that comprise monomer have excessively high viscosities and, because of their high reactivities, can be crosslinked only with diols. Crosslinking with diamines, e.g. MOCA (4,4′-methylenebis(2-chloroaniline) or Ethacure® 300 (isomer mixture made of 3,5-dimethylthio-2,6-toluenediamine and 3,5-dimethylthio-2,4-toluenediamine) would be much too reactive. Although TDI- or 2,4′-MDI-based NCO prepolymers can be crosslinked with amines to give elastomers, without thin-layer distillation, within acceptable processing times of >1 minute, the corresponding reaction mixtures of NCO prepolymer and crosslinking agent are not sufficiently stable in storage.

It was therefore an object to provide a polyurethane system which exhibits stability of the polyurethane mixture over a long period in storage, and therefore long pot life, and which at the same time can be used to produce thick-walled parts, and which requires no expensive thin-layer distillation. At the same time, the intention was not to use TDI-based systems. The polyurethane system should moreover give products which have no, or only slight, differences in their physical properties throughout the entire thick-walled polyurethane product produced (“product homogeneity”). Another intention was that the starting materials have low processing viscosity, so that products or elastomers obtained are bubble-free, without any disruption of the mixing process, and that the polyurethane products produced therefrom have good properties. Another intention was that it be possible to use the starting materials to produce a wide range of tailored polyurethane elastomers with good final properties.

Surprisingly, the object was achieved via polyurethane moldings based on 2,4′-MDI prepolymers and on MDA complexes.

The present invention provides polyurethane elastomer moldings obtainable by the casting process, obtainable via reaction of
a) NCO prepolymers with viscosity <3000 mPas at 80° C., with NCO content of from 3 to 7% by weight and with from 1% by weight to 6% by weight, preferably from 1 to 5% by weight, content of free monomeric diphenylmethane 2,4′-diisocyanate, based on the NCO prepolymer, obtainable via reaction of diphenylmethane diisocyanate with at least 95% by weight, preferably at least 97.5% by weight, 2,4′-isomer content and of polyols with OH numbers of from 50 to 180 mg KOH/g and with functionality 2, where the index (ratio of NCO groups to OH groups) is from 1.6:1 to 2.1:1, with
b) complexes made of 4,4′-diaminodiphenylmethane (MDA) and of metal salts,
   in the presence of
c) optionally auxiliaries and additives and
d) optionally plasticizers.

The NCO prepolymer used in the invention does not have low monomer content. It comprises a high proportion of prepolymers having ABABA structures and correspondingly higher-level structures (A=isocyanate and B=polyol).

The diphenylmethane diisocyanate (MDI) used for the production of the prepolymer is composed of at least 95% by weight of 2,4′-MDI, the remainder being 4,4′-MDI and 2,2′-MDI.

2,4′-MDI hereinafter means monomeric MDI which comprises at least 95% by weight content of 2,4′-isomer, particularly preferably at least 97.5% by weight.

The reaction mixtures blended from the abovementioned starting compounds a) and b) are stable in storage/flowable at 70° C. and at lower temperatures for at least one month.

The polyols are preferably polytetramethylene glycols, polycaprolactones, poly-adipates, and mixtures of these, and it is particularly preferable here to use poly-tetramethylene glycols with number-average molar masses of from 650 g/mol to 1400 g/mol, polycaprolactone polyols with number-average molar masses of from 800 to 1700 g/mol, polyadipates with number-average molar masses of from 700 to 2000 g/mol, and mixtures of these.

The complexes are preferably complexes of metal halides, particularly preferably of sodium chloride and MDA.

A particularly preferred complex used is a complex based on 4,4′-MDA with NaCl in dioctyl adipate, where the complex comprises <0.5% content of uncomplexed 4,4′-MDA.

Surprisingly, the polyurethane moldings of the invention exhibited homogeneous distribution of properties throughout the entire product.

The invention further provides a method for the production of polyurethane elastomer moldings by the casting process,

where
(i) in a first step
a) NCO prepolymers with viscosity <3000 mPas at 80° C., with NCO content of from 3 to 7% by weight and with from 1% by weight to 6% by weight, preferably from 1 to 5% by weight, content of free monomeric diphenylmethane 2,4′-diisocyanate, based on the NCO prepolymer, obtainable via reaction of diphenylmethane diisocyanate with at least 95% by weight, preferably at least 97.5% by weight, 2,4′-isomer content and of polyols with OH numbers of from 50 to 180 mg KOH/g and with functionality 2, where the index (ratio of the NCO groups to the OH groups) is from 1.6:1 to 2.1:1,
b) complexes made of 4,4′-diaminodiphenylmethane (MDA) and of metal salts,
c) optionally auxiliaries and additives and
d) optionally plasticizers are mixed with one another,
(ii) optionally the reaction mixture obtained in step (i) is stored at temperatures of 70° C. or below,
(iii) the reaction mixture is charged to a mold,
(iv) the reaction mixture is hardened at temperatures above 80° C., preferably above 100° C., particularly preferably above 110° C., to at most 160° C., preferably to at most 150° C., to give the polyurethane,
(v) the hardened polyurethane is removed from the mold.

The index is defined as the ratio of NCO groups to OH/NH₂ groups. The stoichiometry is the ratio of OH/NH₂ groups to NCO groups. Alongside the prepolymer index and prepolymer stoichiometry there is also the elastomer index and elastomer stoichiometry. The elastomer stoichiometry is the ratio of OH/NH₂ groups of the crosslinking agent to the NCO groups of the prepolymer. The elastomer index is the ratio of NCO groups of the prepolymer to the OH/NH₂ groups of the crosslinking agent.

Polyols that can be used are polyether polyols, polyester polyols, polycaprolactone polyols, polycarbonate polyols, and polyetherester polyols respectively having hydroxy numbers of from 50 to 180 mg KOH/g. It is preferable to use polyols with functionality 2.

Polyether polyols are by way of example produced by means of alkaline catalysis or by means of double-metal-cyanide catalysis or optionally with staged conduct of a reaction by means of alkaline catalysis and double-metal-cyanide catalysis from a starter molecule and from epoxides, preferably ethylene oxide and/or propylene oxide, and have terminal hydroxy groups. Starters that can be used here are the compounds known to the person skilled in the art having hydroxy and/or amino groups, and also water. The functionality of the starters here is at least 2 and at most 4. It is also possible, of course, to use mixtures of a plurality of starters. It is also possible to use, as polyether polyols, mixtures of a plurality of polyether polyols.

It is also possible to use, as polyether polyols, hydroxy-terminated oligomers of tetrahydrofuran, known as poly-C4-ethers/polytetrahydrofurans/polytetramethylene glycols. These are mostly produced by using acidic catalysis.

Polyester polyols are produced in a manner known per se via polycondensation from aliphatic and/or aromatic polycarboxylic acids having from 4 to 16 carbon atoms, optionally from anhydrides of these, or else optionally from low-molecular-weight esters of these, inclusive of ring esters, mostly with use of low-molecular-weight polyols having from 2 to 12 carbon atoms as reaction component. The functionality of the structural components for polyester polyols is preferably 2. Polyetherester polyols are produced via concomitant use of polyether polyols in the synthesis of a polyester polyol. Polycarbonate polyols are obtained by means of polycondensation as in the prior art from carbonic acid derivatives, e.g. dimethyl or diphenyl carbonate, or phosgene, and from polyols.

The expression MDA complexes means the compounds described in U.S. Pat. No. 3,755,261, U.S. Pat. No. 3,876,604, U.S. Pat. No. 4,029,730, and also US2008/014765. These are reaction products of MDA with metal salts, e.g. sodium chloride, sodium bromide, sodium iodide, lithium chloride, lithium bromide, lithium iodide, and also sodium cyanide. Pseudohalides have also been described. Preference is given to metal salt complexes of MDA, particularly to metal halide complexes of MDA. It is very particularly preferable to use complexes based on 4,4′-MDA, and it is particularly preferable here to use sodium chloride complexes. This complex takes the form of A/MA*3NaCl. The complexes usually take the form of dispersions, e.g. in plasticizers, such as dioctyl phthalate or dioctyl adipate. It is preferable to use complexes with low content of free (uncomplexed) MDA. Known techniques (recrystallization, filtration, thin layers, extraction, etc.) are optionally used to remove the free MDA. Complexes of this type are obtainable commercially from Chemtura with trademark Caytur® or Duracure™.

It is also possible to use auxiliaries and additives, such as catalysts, UV stabilizers, hydrolysis stabilizers, other stabilizers, silicones, emulsifiers, and preferably incorporable dyes, and also color pigments.

Examples of catalysts are trialkylamines, diazabicyclooctane, tin dioctoate, dibutyltin dilaurate, N-alkylmorpholine, lead octoate, zinc octoate, calcium octoate, magnesium octoate, the corresponding naphthenates, and p-nitrophenolate.

The reaction between the prepolymer and MDA complex is catalyzed not only by the known catalysts but also by polar compounds, such as glycerol or urea. These specific catalysts do not catalyze the reaction between the NCO groups and NH₂ groups, but instead weaken the blocking of the MDA by the metal salt in such a way that the complex can react even at low temperatures.

Examples of plasticizers that can be used are compounds such as phthalates (e.g. dibutyl phthalates, diisononyl phthalates), trimellitates, adipates (e.g. dioctyl adipates), organophosphates (e.g. tributyl phosphates), chloro- and/or bromophosphates, carbonates (e.g. propylene carbonate), lactones (e.g. butyrolactone), and the like.

Examples of stabilizers are Bronstedt and Lewis acids, e.g. hydrochloric acid, benzoyl chloride, organomineral acids, e.g. dibutyl phosphate, and also adipic acid, malic acid, succinic acid, racemic tartaric acid, or citric acid.

Silicones are often added for degassing and/or as abrasion reducers. Examples of commonly used additives are obtainable from Byk (Altana) or Evonik (Tegostab, Ortegol, or the like).

Examples of UV stabilizers and hydrolysis stabilizers are 2,6-dibutyl-4-methylphenol and sterically hindered carbodiimides.

Incorporable dyes are those having hydrogen atoms that have Zerevitinov activity, i.e. dyes that can react with NCO groups.

Other auxiliaries and additives comprise emulsifiers, foam stabilizers, cell regulators, and fillers. An overview is given in G. Oertel, Polyurethane Handbook, 2^{nd} edition, Carl Hanser Verlag, Munich, 1994, chapter 3.4.

The polyurethane elastomers of the invention can be used in a very wide variety of sectors: for example in the form of resilient moldings which are produced by the casting process. Examples of typical applications are sieves, rollers and wheels, rolls, and hydrocyclones.

A microwave-based hardening process is also possible, alongside thermal hardening to give the elastomer in step (iv).

The invention will be explained in more detail by using the examples below.

### EXAMPLES

Test Methods Used:

| Property | Dimension | Standard |
|---|---|---|
| Hardness | [Shore] | ISO 868 |
| Tensile stress | [MPa] | DIN 53504 |
| Tensile stress at break | [MPa] | DIN 53504 |
| Tensile strain at break | [%] | DIN 53504 |
| Tear-propagation resistance | [kN/m] | DIN 53515 |
| Abrasion | [mm³] | DIN 53516 |
| Density | [g/mm³] | ISO 1183 |
| Compression set, CS | [%] | ISO 815 |
| Viscosity | mPas | ISO 3219/A.3 |
| NCO content | % by wt. | ISO 11909 |

Starting materials Used:
Polyol 1 Polytetramethylene glycol (from Invista, Terathane® 650) molar mass 650 g/mol, nominal functionality 2.0, OH number 173 mg KOH/g
Polyol 2 Polytetramethylene glycol (from Invista, Terathane® 1000) molar mass 1000 g/mol, nominal functionality 2.0, OH number 112 mg KOH/g
Polyol 3 Polycaprolactone polyol (from Perstorp, Capa 2101A) molar mass 1000 g/mol, nominal functionality 2.0, OH number 112 mg KOH/g
Polyol 4 Polycaprolactone polyol (from Perstorp, Capa 2201A) molar mass 2000 g/mol, nominal functionality 2.0, OH number 56 mg KOH/g
Isocyanate 1: Diphenylmethane 4,4′-diisocyanate (Desmodur® VP.PU 0118B from Bayer MaterialScience AG) with 98.5% by weight content of 4,4′-isomer
Isocyanate 2: Diphenylmethane 2,4′-diisocyanate (Desmodur® 24 MI from Bayer MaterialScience AG) with 99.0% by weight content of 2,4′-isomer
Isocyanate 3: Mixture of 60% of diphenylmethane 2,4′-diisocyanate and 40% of diphenylmethane 4,4′-diisocyanate (Desmodur® VP.PU 0129 from Bayer MaterialScience AG)
Caytur® 31 DA: Mixture of 47% by weight of 4,4′-diphenylmethanediamine with NaCl (taking the form of MDA3*NaCl according to the producer) and 53% by weight of dioctyl adipate obtainable from Chemtura Corporation
Adiprene® Duracast™ C930: Low-monomer-content NCO prepolymer based on 4,4′-MDI and on polycaprolactone polyols with from 4.35 to 4.55% by weight NCO content and with viscosity 1000 mPas at 80° C.; this is an ABA prepolymer; hereinafter termed prepolymer 8

General Prepolymer Production Specification:

The appropriate amount of isocyanate was heated to 50° C. in a stirred flask, and rapidly mixed at 70° C. with the appropriate amount of the polyol mixture. The mixture was allowed to continue reaction at 85° C. in vacuo for 3 hours, and properties were determined. Since NCO groups are moisture-sensitive, all further investigations/experiments, especially the storage experiments, were as far as possible carried out with exclusion of moisture (e.g. in vacuo or under inert gas, for example dry air or dry nitrogen).

General Production Specification for the Production of Elastomer Moldings with Caytur® 31 DA as Crosslinking Agent:

The prepolymer was degassed at 80° C. in vacuo with slow stirring until free from bubbles. Caytur® 31 DA was kept in motion in the drum at 30° C. for 24 h prior to use. The appropriate amount was then added at 25° C. to the prepolymer. Degassing time was 5 minutes. The mixture was cast in molds at 125° C. The elastomer was demolded and post-conditioned for 16 hours at 115° C.

General Production Specification for the Production of Cast Elastomers with MOCA as Crosslinking Agent:

The prepolymer was degassed at 80° C. with slow stirring in vacuo until free from bubbles. MOCA was added at 120° C. to the prepolymer. Casting was immediately carried out in molds at 100° C. The elastomer was demolded and post-conditioned for 16 hours at 100° C.

Pot life was determined by producing a 400 g mixture of prepolymer and crosslinking agent. Pot life ends when the mixture starts to gel.

TABLE 1
Formulations of MDI-based prepolymers

| Prepolymer | | 1(I) | 2(I) | 3(I) | 4(I) | 5(C) | 6(C) | 7(C) | 8(C)* |
|---|---|---|---|---|---|---|---|---|---|
| Polyol 1 | [% by wt.] | 37.61 | | | | 37.61 | 37.61 | | |
| Polyol 2 | [% by wt.] | 25.07 | 70.0 | | | 25.07 | 25.07 | 65.7 | |
| Polyol 3 | [% by wt.] | | | 54.75 | 39.37 | | | | yes |
| Polyol 4 | [% by wt.] | | | 13.69 | 32.21 | | | | yes |
| Isocyanate 1 | [% by wt.] | | | | | 37.32 | | | yes |
| Isocyanate 2 | [% by wt.] | 37.32 | 30.0 | 31.56 | 28.42 | | | 34.3 | |
| Isocyanate 3 | [% by wt.] | | | | | | 37.32 | | |
| NCO content (theoret.) | [% by wt. of NCO] | 5.57 | 4.20 | 5.43 | 4.89 | 5.57 | 5.57 | 6.0 | 4.35-4.55 |
| NCO content (exp.) | [% by wt. of NCO] | 5.57 | 4.05 | 5.25 | 4.67 | 5.30 | 5.55 | 5.95 | |
| Prepolymer index | NCO/OH groups | 1.8 | 1.72 | 2.05 | 2.05 | 1.8 | 1.8 | 2.09 | |
| Free MDI | [% by wt.] | 3.1 | 1.1 | 5.0 | 4.6 | 6.15 | 5.03 | 6.5 | <0.1 |
| Viscosity at 80° C. | [mPas] | 900 | 1350 | 1400 | 1600 | 9250 | 1700 | 650 | 1000 |

I—in the invention;
C—comparison
*The values for example 8 were taken from the literature.

Prepolymers 1, 5, and 6 were respectively produced from polytetrahydrofuran and MDI, and have the same index and the same NCO content. Prepolymer 1 of the invention was produced from pure 2,4′-MDI and has markedly lower free MDI content, and also markedly lower viscosity, than prepolymers 5 and 6. Prepolymer 2 of the invention has lower NCO content than prepolymer 1 with low viscosity. It was not then possible to produce corresponding prepolymers with low NCO content by analogy with prepolymer 2 on the basis of 4,4′-MDI or mixtures of 4,4′-MDI and 2,4′-MDI, since viscosity was much too high. It was likewise not possible to achieve production of prepolymers by analogy with experiments 3 and 4 but based on 4,4′-MDI/mixtures of 4,4′-MDI and 2,4′-MDI, because viscosities were much too high. Surprisingly, the use of pure 2,4′-MDI for producing prepolymers with low free MDI content and with low viscosity is therefore extremely advantageous.

Although prepolymer 7 has very low viscosity in comparison with prepolymer 1, the index is higher and content of free MDI is markedly higher. These prepolymers cannot then be used to produce large-thickness elastomer parts, as revealed hereinafter.

TABLE 2a
Formulations, production, and properties of elastomer moldings (effect of conditioning)

| Formulation and production: | | | | | | | |
|---|---|---|---|---|---|---|---|
| Prepolymer | No. | 3 | 3 | 3 | 8 | 8 | 4 |
| Amount | [pts. by wt.] | 100 | 100 | 100 | 100 | 100 | 100 |
| Caytur ® 31DA | [pts. by wt.] | 29.1 | 29.1 | 29.1 | 24.7 | 24.7 | 25.9 |
| Temperature of Caytur ® 31DA | [° C.] | 25 | 25 | 25 | 25 | 25 | 25 |
| Prepolymer temperature | [° C.] | 80 | 80 | 80 | 90 | 90 | 80 |
| Elastomer stoichiometry | | 0.95 | 0.95 | 0.95 | 0.95 | 0.95 | 0.95 |
| Mold temperature | [° C.] | 125 | 125 | 125 | 127-140 | 127-140 | 125 |
| After-heating temperature | [° C.] | 100 | 115 | 140 | 127 | 140 | 115 |
| After-heating time | [h] | 24 | 24 | 24 | 24 | 24 | 24 |
| Homogeneous properties throughout a block measuring | | yes | yes | yes | no | no | yes |
| 30 * 30 * 10 cm³ | | | | | | | |
| Block measuring 30 * 30 * 10 cm³ can be produced | | yes | yes | yes | yes | yes | yes |
| Hardening of layers >10 mm | | yes | yes | yes | yes | yes | yes |
| Mechanical properties: | | | | | | | |
| Hardness | [Shore A] | 93 | 93 | 93 | 93-95 | 93-95 | 90 |
| | [Shore D] | | | | | | |
| Tensile stress, 10% | [MPa] | 4.4 | 4.2 | 4.5 | | | 3.6 |
| Tensile stress, 100% | [MPa] | 8.4 | 8.9 | 8.8 | 9.1 | 9.65 | 7.5 |
| Tensile stress, 200% | [MPa] | 10.0 | 10.3 | 10.2 | | | 8.9 |
| Tensile stress, 300% | [MPa] | 12.4 | 12.3 | 12 | 12.76 | 11.72 | 10.7 |
| Tensile stress at break | [MPa] | 49 | 46 | 45 | 43.44 | 42.05 | 49 |
| Tensile strain at break | [%] | 570 | 585 | 615 | 525 | 600 | 585 |
| Tear-propagation resistance, without scratch | [kN/m] | 106 | 108 | 110 | | | 100 |
| Tear-propagation resistance, with scratch | [kN/m] | 75 | 75 | 78 | | | 63 |
| Tear-propagation resistance in accordance with ASTM | | | | | 57.8 | 81.3 | |
| D1938 | | | | | | | |
| Resilience | [%] | 38 | 36 | 35 | 60 | 60 | 42 |
| Abrasion (DIN) | [mm³] | 65 | 60 | 70 | | | 50 |
| Density | [g/mm³] | 1.16 | 1.16 | 1.17 | | | 1.16 |
| CS 20° C./72 h | [%] | 27 | 25 | 26 | | | 20 |
| CS 70° C./22 h | [%] | 42 | 42 | 40 | 24 | 23 | 33 |

The elastomers of the invention exhibit almost no change in their properties for various conditioning methods. Elastomers based on 4,4′-MDI made of corresponding prepolymers subjected to thin-layer distillation (prepolymer 8) have very high tear-propagation resistance when post-conditioned at 140° C., this being 40% higher than that of the elastomers post-conditioned at 127° C. This is all the more astounding since the post-conditioning temperature was increased by only 13° C. The elastomers of the invention exhibit no property change over a temperature range from 100 to 140° C. This is of particularly high importance when large parts have to be produced. Polyurethane is an insulator, and temperatures prevailing in the core of the polyurethane molding are substantially higher than at the surface in contact with the mold. By way of example, a temperature of 140° C. can easily be achieved within the core when the mold temperature is 100° C. The elastomers made from prepolymers subjected to thin-layer distillation (prepolymer 8) do not exhibit homogeneous properties.

TABLE 2b
Formulations, production, and properties of cast elastomers of the invention (reaction mixtures stable
in storage compared with mixtures that are not stable in storage (using MOCA as amine crosslinking agent))

| Formulation and production: | | | | | | | | | | | |
|---|---|---|---|---|---|---|---|---|---|---|---|
| Prepolymer | No. | 3 | 3 | 3 | 3 | 1 | 1 | 1 | 1 | 2 | 2 |
| | [pts. by wt.] | 100 | 100 | 100 | 100 | 100 | 100 | 100 | 100 | 100 | 100 |
| Caytur ® 31DA | [pts. by wt.] | 29.1 | 29.1 | 29.1 | | 30.9 | 30.9 | 30.9 | | 22.4 | |
| MOCA | [pts. by wt.] | | | | 15.9 | | | | 16.8 | | 12.2 |
| Temperature of Caytur ® 31DA | [° C.] | 25 | 25 | 25 | | 25 | 25 | 25 | | 25 | |
| Temperature of MOCA | [° C.] | | | | 120 | | | | 120 | | 120 |
| Prepolymer temperature | [° C.] | 90 | 90 | 90 | 90 | 90 | 90 | 90 | 90 | 80 | 80 |
| Elastomer stoichiometry | | 0.95 | 0.95 | 0.95 | 0.95 | 0.95 | 0.95 | 0.95 | 0.95 | 0.95 | 0.95 |
| Pot life at 70° C., prepolymer | | >3 | >3 | >3 | 4 min | >3 | >3 months | >3 months | 3 min | >3 months | 5 min |
| | | months | months | months | | months | | | | | |
| Pot life at 90° C., prepolymer | | 1 h | 1 h | 1 h | 2 min | 1 h | 1 h | 1 h | 2 min | 1 h | 2 min |
| Pot life at 125° C. prep. | | 8 min | 8 min | 8 min | <1 min | 8 min | 8 min | 8 min | <1 min | 8 min | <1 min |
| Start of casting process after | [h] | 0 | 7 | 24 | 0 | 0 | 7 | 24 | 0 | 0 | 0 |
| Mold temperature | [° C.] | 125 | 125 | 125 | 110 | 125 | 125 | 125 | 110 | 125 | 110 |
| After-heating temp. | [° C.] | 115 | 115 | 115 | 115 | 115 | 115 | 115 | 115 | 115 | 115 |
| After-heating time | [h] | 24 | 24 | 24 | 24 | 24 | 24 | 24 | 24 | 24 | 24 |
| Homogeneous properties | | yes | yes | yes | n.d. | yes | yes | yes | n.d. | yes | n.d. |
| throughout a block measuring | | | | | | | | | | | |
| 30 * 30 * 10 cm³ | | | | | | | | | | | |
| Block measuring | | yes | yes | yes | yes | yes | yes | yes | yes | yes | yes |
| 30 * 30 * 10 cm³ can be | | | | | | | | | | | |
| produced | | | | | | | | | | | |
| Hardening of layers | | yes | yes | yes | yes | yes | yes | yes | yes | yes | yes |
| >10 mm | | | | | | | | | | | |
| Mechanical properties: | | | | | | | | | | | |
| Hardness | [Shore A] | 93 | 93 | 93 | 97 | 96 | 96 | 96 | 98 | 92 | 95 |
| | [Shore D] | | | | | 47 | 45 | 45 | 56 | | |
| Tensile stress, 10% | [MPa] | 4.2 | 4.2 | 4.2 | 3.2 | 7.1 | 6.8 | 6.5 | 11.9 | 3.2 | 5.4 |
| Tensile stress, 100% | [MPa] | 8.9 | 8.1 | 9.5 | 6.5 | 12.9 | 12.7 | 12.6 | 20.9 | 6.8 | 11.3 |
| Tensile stress, 200% | [MPa] | 10.3 | 9.7 | 11 | 9.1 | 14.7 | 14.7 | 14.4 | 26.2 | 9.0 | 14.6 |
| Tensile stress, 300% | [MPa] | 12.3 | 11.8 | 13.1 | 13.4 | 17.4 | 17.6 | 16.8 | 32.3 | 11.4 | 18.2 |
| Tensile stress at break | [MPa] | 46 | 53 | 43 | 54 | 43 | 41 | 40 | 50 | 46 | 38 |
| Tensile strain at break | [%] | 585 | 620 | 595 | 496 | 532 | 529 | 545 | 440 | 584 | 500 |
| Tear-propagation | [kN/m] | 110 | 106 | 121 | 101 | 130 | 130 | 135 | 161 | 99 | 127 |
| resistance, without scratch | | | | | | | | | | | |
| Tear-propagation | [kN/m] | 79 | 74 | 88 | 61 | 87 | 84 | 86 | 131 | 39 | 47 |
| resistance, with scratch | | | | | | | | | | | |
| Resilience | [%] | 36 | 36 | 36 | 31 | 39 | 38 | 35 | 36 | 48 | 37 |
| Abrasion (DIN) | [mm³] | 60 | 65 | 65 | 65 | 65 | 65 | 65 | 40 | 45 | 40 |
| Density | [g/mm³] | 1.16 | 1.16 | 1.16 | 1.17 | 1.1 | 1.1 | 1.1 | 1.14 | 1.09 | 1.11 |
| CS 20° C./72 h | [%] | 25 | 27 | 27 | 18 | 25 | 25 | 24 | 23 | 23 | 23 |
| CS 70° C./22 h | [%] | 42 | 43 | 42 | 29 | 34 | 36 | 35 | 24 | 39 | 25 |

From table 2b it can be seen that even 24 hours after mixing of Caytur® 31 DA and the prepolymer, the reaction mixture based on prepolymer 3 still gives test specimens with properties identical with those produced directly after mixing. It was also found that the blocks produced in the invention had homogeneous hardness and that the reaction mixtures hardened without difficulty. Homogeneity was determined by dissecting a block and measuring hardness in the center, at the top, and at the bottom. If the hardness difference is at most one Shore A hardness unit, the term homogeneous is used. Reaction mixtures produced with a crosslinking agent, e.g. MOCA, have an available processing time of 2 minutes, whereas the reaction mixtures of the invention remain castable/flowable for months.

TABLE 2c
Formulations, production, and properties of cast
elastomers not of the invention (comparison)

| Formulation and production: | No. | 5 | 6 | 7 |
|---|---|---|---|---|
| Prepolymer | [pts. | 100 | 100 | 100 |
| | by wt] | | | |
| Caytur ® 31DA | [pts. | 29.4 | 30.8 | 33.0 |
| | by wt.] | | | |
| Temperature of Caytur ® | [° C.] | 25 | 25 | 25 |
| 31DA | | | | |
| Prepolymer temperature | [° C.] | 90 | 90 | 90 |
| Elastomer stoichiometry | | 0.95 | 0.95 | 0.95 |
| Pot life at 70° C., | | begins | begins | begins |
| prepolymer | | to gel | to gel | to gel |
| | | after | after | after |
| | | 24 h | 24 h | 24 h |
| Mold temperature | [° C.] | 125 | 125 | 125 |
| After-heating temperature | [° C.] | 115 | 115 | 115 |
| After-heating time | [h] | 16 | 16 | 1 |
| Homogeneous properties | | no | no | no |
| throughout a block | | | | |
| measuring 30*30*10 cm³ | | | | |

| | |
|---|---|
| Block measuring | It was not possible to |
| 30*30*10 cm³ | produce a block. The mixtures |
| can be produced | were therefore discarded. |
| Hardening of | no |
| layers >10 mm | |

From the examples it can be seen that not only must the prepolymers be based on 2,4′-MDI but another requirement in order to permit hardening in a block is that they have low free MDI content. The object cannot therefore be achieved by using reaction mixtures of NCO prepolymers produced from mixtures of 2,4′-MDI and 4,4′-MDI. Nor can reaction mixtures based on NCO prepolymers made of 2,4′-MDI with more than 6% by weight of free 2,4′-MDI achieve the object.

1-2. (canceled)

3. A polyurethane elastomer molding obtained by a casting process, and obtained by reacting
a) an NCO prepolymer having a viscosity <3000 mPas at 80° C., an NCO content of from 3 to 7% by weight and a content of free monomeric diphenylmethane 2,4′-diisocyanate of from 1% by weight to 6% by weight, based on the NCO prepolymer, wherein said NCO prepolymer is obtained by reacting diphenylmethane diisocyanate having at least 95% by weight 2,4′-isomer content with a polyol having an OH number of from 50 to 180 mg KOH/g and a functionality of 2, wherein the index is from 1.6:1 to 2.1:1, with
b) a complex made of 4,4′-diaminodiphenylmethane and a metal salt, in the presence of
c) optionally an auxiliary and/or an additive; and
d) optionally a plasticizer.

4. A method for producing a polyurethane elastomer molding by a casting process, which comprises
(i) mixing
a) an NCO prepolymer having a viscosity <3000 mPas at 80° C., an NCO content of from 3 to 7% by weight and a content of free monomeric diphenylmethane 2,4′-diisocyanate of from 1% by weight to 6% by weight, based on the NCO prepolymer, wherein said NCO prepolymer is obtained by reacting diphenylmethane diisocyanate having at least 95% by weight 2,4′-isomer content with a polyol having an OH number of from 50 to 180 mg KOH/g and a functionality of 2, wherein the index is from 1.6:1 to 2.1:1,
b) a complex made of 4,4′-diaminodiphenylmethane and a metal salt,
c) optionally an auxiliary and/or an additive; and
d) optionally a plasticizer,
to form a reaction mixture,
(ii) optionally storing the reaction mixture obtained in step (i) at a temperature ≦70° C.,
(iii) charging the reaction mixture to a mold,
(iv) hardening the reaction mixture at a temperature in the range of greater than 80° C. to 150° C. to give said polyurethane elastomer molding, and
(v) removing the polyurethane elastomer molding from the mold.
